(19) United States
(12) Patent Application Publication
(10) Pub. No.: US 2007/0258858 A1
(43) Pub. Date: Nov. 8, 2007

(54) Robotic gripper for transporting multiple object types

(76) Inventors: Brian Rasnow, Newbury Park, CA (US); Chuck Li, Thousand Oaks, CA (US); Stephen Robert Wilson, Victoria (AU)

Correspondence Address: FOLEY & LARDNER LLP, 150 EAST GILMAN STREET, P.O. BOX 1497, MADISON, WI, 53701-1497, US

(21) Appl. No.: 11/417,271

(22) Filed: May 3, 2006

(51) Int. Cl. G01N 35/00; B01L 9/00

(52) U.S. Cl. 422/63; 422/104

(57) ABSTRACT

A gripping apparatus is provided that includes a sensor, an actuator, a base, and a plurality of fingers extending relative to the base to grip an object that is one of a plurality of object types. A first finger includes a first support surface located a first distance relative to the base and a second support surface located a second distance relative to the base. The first distance is selected based on a first object type, and the second distance is selected based on a second object type. The second finger includes a third support surface located the first distance relative to the base and a fourth support surface located the second distance relative to the base. The first finger opposes the second finger. The actuator is operably coupled to the sensor(s) to effect movement at least one of the fingers to hold an object detected by the sensor.

### FIELD OF THE INVENTION

The subject of the disclosure relates generally to a gripping apparatus mounted on a robotic arm for transporting objects. More specifically, the disclosure relates to a single gripping apparatus for transporting various types of objects such as plates, pipette tip flats, etc. used in an automated instrument.

### BACKGROUND OF THE INVENTION

Robotic arms have been incorporated into instruments to transport objects during the conduct of experiments to support higher throughput and unattended processing of the experiments. During the conduct of experiments, pipette tips are commonly used to aspirate and to dispense liquids. Typically, the pipette tips are placed on pipette tip heads and inserted into a number of wells of the instrument, with the arrangement of the pipette tips chosen to be compatible with industry standard multi-well plates. The robotic arm positions the pipette tips into the wells of the plate, and liquid is aspirated from the wells into the pipette tips, or liquid is dispensed from the pipette tips into the wells. As a result, pipette tips are normally sold packaged in flats or racks which hold the tips in the standard spacing for placement on pipette tip heads and insertion in the multi-well plates. During the conduct of experiments other objects may be transported using the robotic arms. For example, in instruments providing high throughput drug screening, object include various standard pipette tip flats or racks, multi-well plates and lids, reagent containers, barcode readers, etc.

Existing robotic arms include a gripping apparatus designed to transport a single type of object. For example, a gripping apparatus may transport either a multi-well plate or a pipette tip flat, but not either type of object during a single experiment. Additionally, the same gripping apparatus may not support the transport of different format pipette tip flats. For example, the same gripping apparatus may not support the transport of either a 96-pipette tip flat or a 384-pipette tip flat. As a result, a single instrument may require multiple robotic arms or a single robotic arm with multiple gripping apparatus. Use of multiple robotic arms or gripping apparatus increases the cost and the size of the instrument and decreases the throughput and unattended processing time supported by the instrument. Multiple robotic arms or gripping apparatus also increase the complexity of the software controlling the movement of the robotic arm and/or gripping by the gripping apparatus. What is needed therefore, is a single gripping apparatus capable of transporting multiple types of objects.

### SUMMARY OF THE INVENTION

An exemplary embodiment provides an apparatus for gripping a plurality of object types. The gripping apparatus may be advantageously used in a variety of applications, such as for gripping and transporting objects of various types including, but not limited to, containers, vessels, single or multiwell plates, flats, racks, lids, tools, etc., of different types during an experiment conducted using an instrument such as an analytical instrument. Exemplary tools include barcode readers and pin tools. Such a combination of functions in a single gripping apparatus significantly reduces the size of the instrument, simplifies the software used to control the robotic arm and the gripping apparatus, reduces the cost of the instrument, and increases the throughput, capacity, and unattended processing time of the instrument. The gripping apparatus includes a plurality of fingers that extend from a base to grip an object that is one of a plurality of object types. As the open gripping apparatus descends on the object, a sensor stops the vertical motion when it detects the presence of the object, and commands the fingers of the gripping apparatus to close. Appropriate selection of the location of a plurality of support surfaces on the plurality of fingers provides contact with the object at an appropriate location for gripping the object depending on the type of object.

In an exemplary embodiment, the gripping apparatus includes a sensor, an actuator, a base, and the plurality of fingers extending relative to the base. The sensor detects an object that is one of a plurality of object types. The base includes a generally planar surface. A first direction is perpendicular to a plane defined by the generally planar surface of the base. A first finger includes a first support surface and a second support surface. The first support surface is located a first distance relative to the base as measured in the first direction. The second support surface is located a second distance relative to the base as measured in the first direction. The first distance is selected based on a first type of object, and the second distance is selected based on a second type of object, wherein the second distance is different from the first distance. A second finger includes a third support surface located the first distance relative to the base as measured in the first direction and a fourth support surface located the second distance relative to the base as measured in the first direction. The first finger opposes the second finger. The actuator is operably coupled to the sensor to effect movement of at least one of the fingers to hold a detected object.

In another exemplary embodiment, the gripping apparatus includes the sensor, the actuator, the base, and a second plurality of fingers extending relative to the base. A first finger includes a first support surface located a first distance relative to the base as measured in the first direction. The first distance is selected based on the first type of object. A second finger includes a second support surface located a second distance relative to the base as measured in the first direction. The second distance is selected based on the second type of object, wherein the second distance is different from the first distance. A third finger includes a third support surface located the first distance relative to the base and opposes the first finger. A fourth finger includes a fourth support surface located the second distance relative to the base and opposes the second finger.

In yet another exemplary embodiment, the gripping apparatus may be mounted on a robotic arm incorporated in an instrument. A controller operably coupled to the gripping apparatus and to the robotic arm sends a command to detect the object to the gripping apparatus and sends a movement command to the robotic arm to move the gripping apparatus. The instrument may be designed to be used in conjunction with an automated laboratory system.

In still another exemplary embodiment, a method for gripping a plurality of object types is provided. The method includes detecting an object with a sensor in response to a received command, and gripping the detected object with a support surface of the gripping apparatus. The method may further include determining a distance to the object, detecting contact between the object and a contact plate of the gripping apparatus, and/or searching for the object as the gripping apparatus moves toward the object.

Other principal features and advantages of the invention will become apparent to those skilled in the art upon review of the following drawings, the detailed description, and the appended claims.

### BRIEF DESCRIPTION OF THE DRAWINGS

Exemplary embodiments will hereafter be described with reference to the accompanying drawings, wherein like numerals will denote like elements.

FIG. 1 is a top perspective view of a gripping apparatus in accordance with an exemplary embodiment.

FIG. 2 is a bottom perspective view of the gripping apparatus of FIG. 1 in accordance with an exemplary embodiment.

FIG. 3 is a first side view of the gripping apparatus of FIG. 1 holding a plate in accordance with an exemplary embodiment.

FIG. 4 is a perspective view of the gripping apparatus of FIG. 1 holding a pipette tip flat in accordance with an exemplary embodiment.

FIG. 5 is a first side view of the gripping apparatus of FIG. 4 in accordance with an exemplary embodiment.

FIG. 6 is a second side view of the gripping apparatus of FIG. 5 rotated 90 degrees in accordance with an exemplary embodiment.

FIG. 7 is a second side view of the gripping apparatus of FIG. 3 rotated 180 degrees in accordance with an exemplary embodiment.

FIG. 8 is a side view of an instrument including the gripping apparatus of FIG. 1 in accordance with an exemplary embodiment.

FIG. 9 is a perspective view of the gripping apparatus of FIG. 1 gripping a pipette tip flat in accordance with an exemplary embodiment.

FIG. 10 is a first perspective view of the gripping apparatus of FIG. 1 moving a pipette tip flat in accordance with an exemplary embodiment.

FIG. 11 is a second perspective view of the gripping apparatus of FIG. 1 moving a pipette tip flat in accordance with an exemplary embodiment.

FIG. 12 is a third perspective view of the gripping apparatus of FIG. 1 moving a pipette tip flat in accordance with an exemplary embodiment.

FIG. 13 is a perspective view of the gripping apparatus of FIG. 1 moving a plate in accordance with an exemplary embodiment.

### DETAILED DESCRIPTION OF THE EXEMPLARY EMBODIMENTS

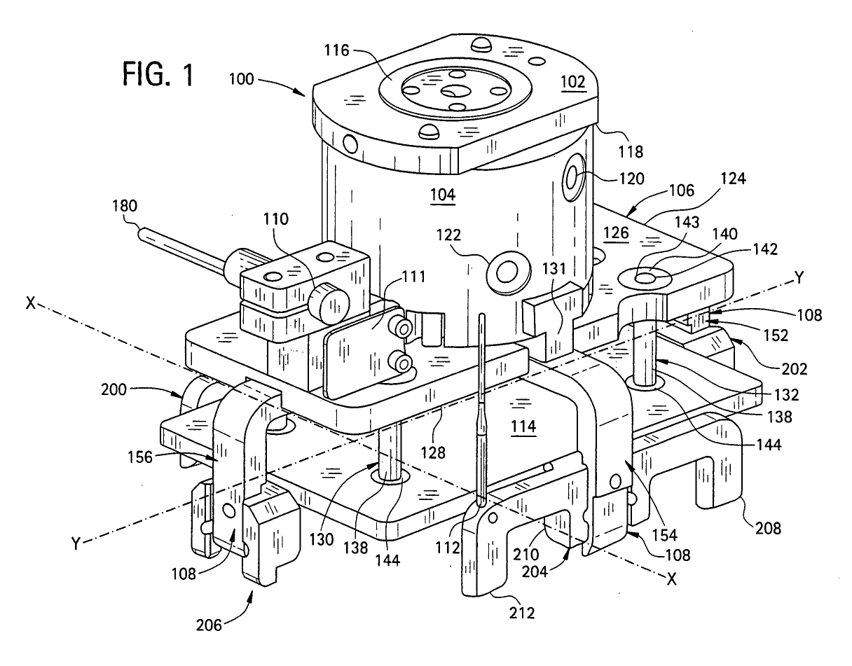

With reference to FIG. 1, a gripping apparatus 100, in accordance with an exemplary embodiment, is shown. Gripping apparatus 100 may include a mounting bracket 102, an actuator housing 104, a base 106, a plurality of fingers 108, a first sensor 110, a second sensor 112, and a contact plate 114. Mounting bracket 102 allows attachment of gripping apparatus 100 to a robotic arm. The robotic arm provides movement in one to three dimensions to position gripping apparatus 100. The robotic arm also may provide rotation of gripping apparatus 100. In another exemplary embodiment, mounting bracket 102 includes a rotary ring 116 that allows gripping apparatus 100 to rotate with respect to an end of the robotic arm. However, gripping apparatus 100 may mount to the robotic arm using a variety of other mechanisms as known to those skilled in the art both now and in the future.

In the exemplary embodiment of FIG. 1, actuator housing 104 mounts between base 106 and a first side 118 of mounting bracket 102 opposite the robotic arm. As used in this disclosure, the term “mount” includes join, unite, connect, associate, insert, hang, hold, affix, attach, fasten, bind, paste, secure, bolt, screw, rivet, solder, weld, and other like terms. An actuator (not shown) is housed within actuator housing 104. The actuator may be any device as known to those skilled in the art both now and in the future for causing movement of one or more actuator jaw. Exemplary actuators include an electric motor, a servo, stepper, or piezo motor, a pneumatic actuator, a gas motor, etc. Actuator housing 104 may have a variety of shapes and sizes to some extent dependent on the actuator selected. Actuator housing 104 may include one or more inlet port 120,122 that accepts a cable connecting the actuator with a power supply, pneumatic supply, and/or a controller.

In the exemplary embodiment of FIG. 1, base 106 includes a plate 124 having a generally rectangular shape though other shapes, including square, circular, elliptical, polygonal, etc., may be used without limitation. Base 106 may be integral with actuator housing 104. Additionally, base 106 need not be a solid surface. For example, base 106 may be formed of a mesh of material. Plate 124 includes a first side 126 and second side 128 opposite first side 126. Second side 128 of plate 124 defines a plane X-Y. Actuator housing 104 mounts adjacent first side 126 of plate 124.

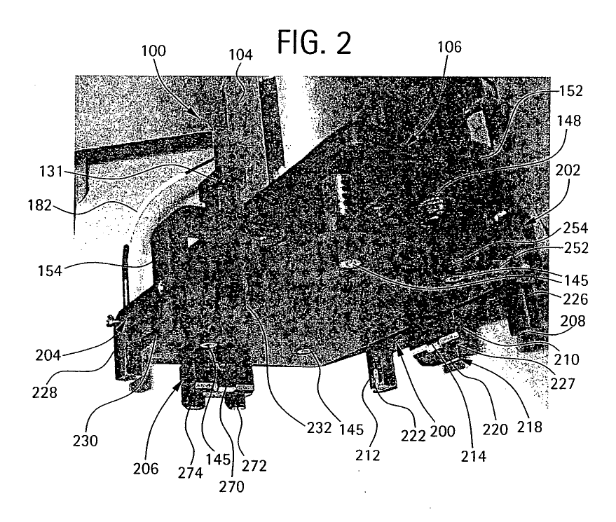

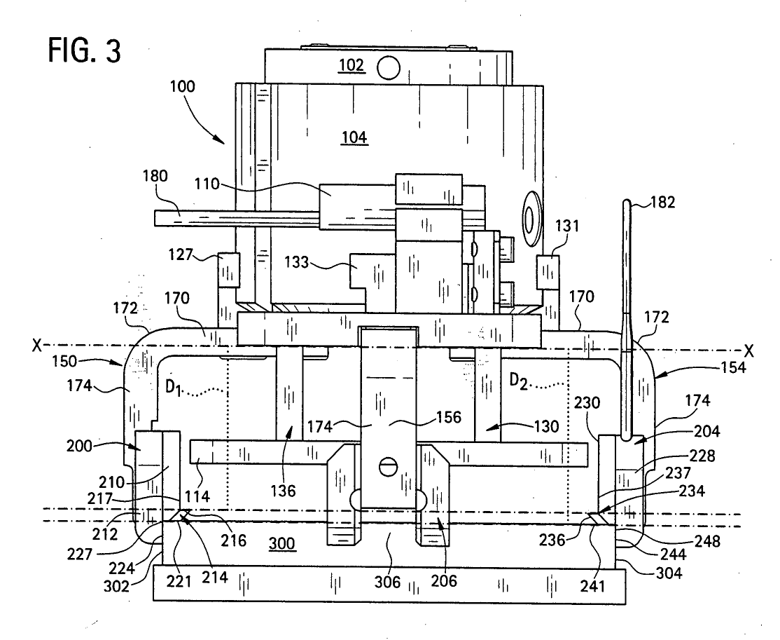

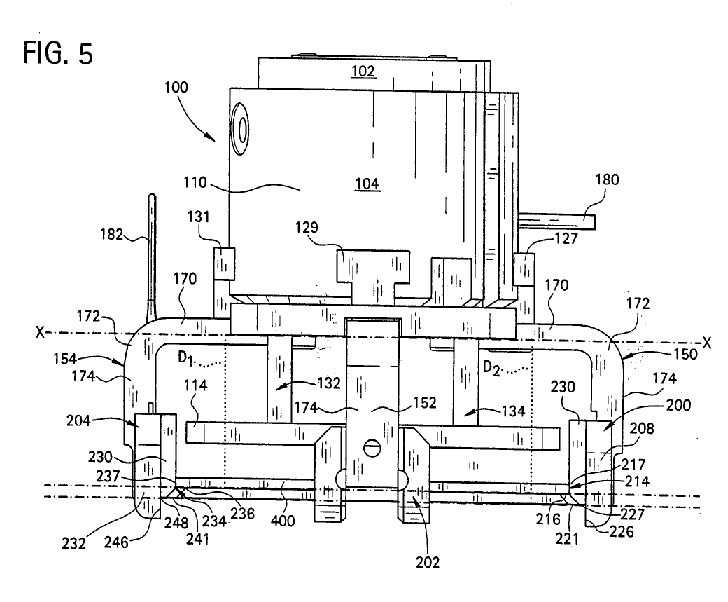

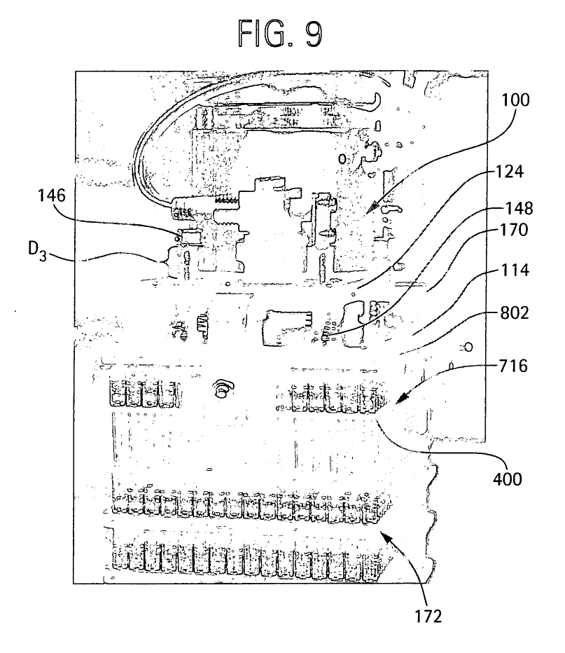

In the exemplary embodiment of FIG. 1, a first stem 130, a second stem 132, a third stem 134 (shown in FIG. 5), and a fourth stem 136 (shown in FIG. 3) connect base 106 with contact plate 114. Each stem 130, 132, 134, 136 includes a shaft 138, a washer 140, a first flange 142, and a second flange 144. Washer 140 of each stem 130, 132, 134, 136 mounts to base 106. In the exemplary embodiment of FIG. 1, the washers 140 of each stem 130, 132, 134, 136 are distributed on the surface of first side 126 of plate 124 outside actuator housing 104 to form a generally rectangular shape though other shapes may be used without limitation. Shaft 138 of each stem 130, 132, 134, 136 extends generally perpendicular to plane X-Y and includes a first end 143 and a second end 145 (shown in FIG. 2) opposite first end 143. Shaft 138 extends through plate 124 and washer 140. First flange 142 extends from first end 143 of shaft 138 in a generally perpendicular direction to shaft 138. First flange 142 supports each stem 130, 132, 134, 136 relative to base 106. A nut 146 (shown in FIGS. 9-11, 13) may mount to first end 143 of shaft 138 in addition to or in place of first flange 142. Second flange 144 extends from second end 145 of shaft 138 in a generally perpendicular direction to shaft 138 and mounts to contact plate 114 to fixedly attach each stem 130, 132, 134, 136 to contact plate 114. Fewer or greater numbers of stems may be used to connect base 106 with contact plate 114. Additionally, different structures may be used to connect base 106 to contact plate 114 as known to those skilled in the art both now and in the future. Use of one or more stem 130, 132, 134, 136 allows relative movement between contact plate 114 and plate 124. Additionally, as shown in FIG. 1, each stem 130, 132, 134, 136 is a passive element, however, one or more stem 130, 132, 134, 136 may be actuated to translate motion to contact plate 114.

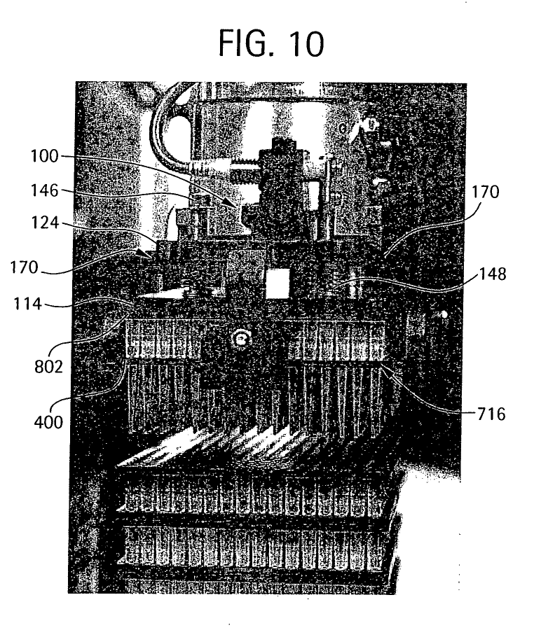

Contact plate 114 has a generally rectangular shape though other shapes, including square, circular, elliptical, polygonal, etc., may be used without limitation. Contact plate 114 may be smaller, larger, or the same size as plate 124. Additionally contact plate 114 may have the same or a different shape than plate 124. In an exemplary embodiment, contact plate 114 includes a planar surface that is generally parallel to plane X-Y defined by plate 124. Contact plate 114 fits within a space defined by the plurality of fingers 108. With reference to FIG. 2, a spring 148 (shown in FIGS. 9 and 10) may encircle each shaft 138 of stems 130, 132, 134, 136 to improve the stability of contact plate 114. Base 106 may further include an air inlet and manifold to remove any objects that may adhere to contact plate 114.

The plurality of fingers 108 may include a first finger 150 (shown in FIGS. 3, 5, 6), a second finger 152, a third finger 154, and a fourth finger 156. First finger 150 mounts to a first actuator jaw 127 (shown in FIG. 3). Second finger 152 mounts to a first actuator jaw 129 (shown in FIG. 5). Third finger 154 mounts to a first actuator jaw 131. Fourth finger 156 mounts to a first actuator jaw 133 (shown in FIG. 3). First finger 150 generally opposes third finger 154, and second finger 152 generally opposes fourth finger 156. Each actuator jaw 127, 129, 131, 133 is operably coupled to move under control of the actuator. Additionally, one or more of the plurality of fingers 108 may be integrally formed with an actuator jaw.

In the exemplary embodiment of FIG. 1, each of the plurality of fingers 108 includes a first portion 170, a second portion 172, and a third portion 174 (shown in FIGS. 5-7). First portion 170 extends in a direction generally parallel to plane X-Y of base 106. Thus, first portion 170 of each of the plurality of fingers 108 extends relative to the base. In an exemplary embodiment, first portion 170 mounts to a corresponding actuator jaw 127, 129, 131, 133. In an alternative embodiment, one or more of the plurality of fingers 108 may include only third portion 174 or only second portion 172 in combination with third portion 174, which mount to or are integrally formed with the corresponding actuator jaw 127, 129, 131, 133.

Movement of the actuator jaw 127, 129, 131, 133 results in movement of first portion 170 with respect to base 106, and thus, movement of the corresponding finger of the plurality of fingers 108 in a direction parallel to the X-Y plane. Second portion 172 mounts to first portion 170 forming a 90 degree corner. Larger or smaller angles may be used depending on the relative size of base 106 and contact plate 114. Third portion 174 mounts to second portion 172 opposite first portion 170 and extends away from base 106 in a direction generally perpendicular to plane X-Y. First portion 170, second portion 172, and third portion 174 may be formed of one or more piece of material. At least one of the plurality of fingers 108 is mounted to an actuator jaw such that the actuator can move at least one of the plurality of fingers 108.

In the exemplary embodiment of FIG. 1, first sensor 110 mounts to first side 126 of plate 124 adjacent first stem 130. First sensor 110 detects contact with contact plate 114 and sends a signal indicating contact to the actuator and/or to a controller through cable 180. First sensor 110 additionally may emit a sound or a light wave in a direction generally perpendicular to plane X-Y to search for the object, to detect the object, and/or to determine the distance to the object. First sensor 110 also may determine the withdrawal distance of contact plate 114 after contact with the object by measuring the height of shaft 138 above first side 126 of plate 124. Exemplary sensors include capacitive, inductive, fiber optic, sonar, ultrasound, optical, infrared, microswitch, magnetic, or other types of sensing mechanisms. In the exemplary embodiment of FIG. 1, first sensor 110 includes a flag 111 mounted to first stem 130. After the object contacts contact plate 114, first stem 130 and flag 111 move away from base 106 allowing first sensor 110 to determine the withdrawal distance of contact plate 114.

In the exemplary embodiment of FIG. 1, second sensor 112 mounts to at least one of the plurality of fingers 108 to detect an object. For example, second sensor 112 is an optical sensor such as a through-beam sensor that includes a transmitter and a receiver mounted opposite the transmitter. The transmitter projects a light beam onto the receiver. An interruption of the light beam, for example, by an object to grip, is interpreted as a switch signal by the receiver. Upon interruption, second sensor 112 may send a signal indicating detection of the object to the actuator and/or to the controller through a cable 182 (shown in FIG. 2). Second sensor 112 additionally may emit a sound or a light wave in a direction generally perpendicular to plane X-Y to search for the object and/or to determine the distance to the object. Second sensor 112 also may determine the withdrawal distance of contact plate 114 after contact. Exemplary sensors include capacitive, inductive, fiber optic, sonar, ultrasound, optical, infrared, microswitch, magnetic, or other types of sensing mechanisms.

With reference to FIG. 2, a bottom perspective view of gripping apparatus 100 is shown. Gripping apparatus 100 may further include a first gripper 200 mounted to first finger 150 (shown in FIG. 3), a second gripper 202 mounted to second finger 152, a third gripper 204 mounted to third finger 154, and a fourth gripper 206 mounted to fourth finger 156. The grippers 200, 202, 204, 206 and fingers 150, 152, 154, 156 may be formed of one or more piece of material. Preferably, the grippers 200, 202, 204, 206 are separable from the fingers 150, 152, 154, 156 to facilitate changing of the grippers 200, 202, 204, 206 to support different types of objects. First gripper 200 may include a left arm 208, a body 210, and a right arm 212.

In the exemplary embodiment of FIG. 2, body 210 extends along third portion 174 of first finger 150 and includes a first recess 214 and a second recess 218. As used in this disclosure, the term “recess” describes a variety of structural shapes including notch, cut, indentation, elbow, groove, corner, chamfer, slope, etc. that can provide a frictional or press fit with an edge of an object to be gripped. First recess 214 includes a first support surface 216 (shown in FIG. 3) and a first surface 217 (shown in FIG. 3). First support surface 216 is directed toward third finger 154 and is generally parallel to plane X-Y. First surface 217 abuts first support surface 216 (shown in FIGS. 3, 5, 6) forming a right angle opening toward third finger 154 and base 106 thereby allowing an object to be nested within the right angle formed by first recess 214. Second recess 218 includes a second support surface 220 and a second surface 221 (shown in FIG. 3). Second support surface 220 is directed toward third finger 154 and is generally perpendicular to plane X-Y. Second surface 221 abuts second support surface 220 forming a right angle opening toward third finger 154 and away from base 106 thereby allowing an object to be nested within the right angle formed by second recess 218.

In the exemplary embodiment of FIG. 2, right arm 212 provides a cavity 222 for mounting second sensor 112 and includes a third support surface 224 (shown in FIG. 3). Right arm 212 and left arm 208 generally are symmetrical with respect to body 210. Left arm 208 includes a fourth support surface 226. Third support surface 224 and fourth support surface 226 are generally perpendicular to plane X-Y. In an alternative embodiment, first support surface 216, second support surface 220, and second sensor 112 can be located on first finger 150. In another alternative embodiment, left arm 208 and right arm 212 can be removed from first gripper 200. In another alternative embodiment, second recess 218 can be removed from first gripper 200 or may be used to perform a different function than gripping of an object. First support surface 216 is located a first distance D₁ (shown in FIG. 3) from base 106 in a direction perpendicular to the X-Y plane. Second support surface 220 includes a leading edge 227 that abuts second surface 221 (shown in FIG. 3). Leading edge 227 of second support surface 220 is located the second distance D₂ (shown in FIG. 3) from base 106 in a direction perpendicular to the X-Y plane.

Similarly, third gripper 204 may include a left arm 228, a body 230, and a right arm 232. In the exemplary embodiment of FIG. 3, body 230 extends along third portion 174 of third finger 154 and includes a first recess 234 and a second recess (not shown). First recess 234 includes a first support surface 236 and a first surface 237. First support surface 236 is directed toward first finger 150 and is generally parallel to plane X-Y. First surface 237 abuts first support surface 236 forming a right angle opening toward first finger 150 and base 106 thereby allowing an object to be nested within the right angle formed by first recess 234. Similar to second recess 218 of first gripper 200, the second recess includes a second support surface (not shown) and a second surface 241. The second support surface is directed toward first finger 150 and is generally perpendicular to plane X-Y. Second surface 241 abuts the second support surface forming a right angle opening toward first finger 150 and away from base 106 thereby allowing an object to be nested within the right angle formed by second recess.

Left arm 228 provides a cavity (not shown but similar to cavity 222 of right arm 212) for mounting second sensor 112 and includes a third support surface 244. With reference to FIGS. 3 and 5, right arm 232 and left arm 228 generally are symmetrical with respect to body 230. Right arm 232 includes a fourth support surface 246. Third support surface 244 and fourth support surface 246 are generally perpendicular to plane X-Y. In an alternative embodiment, first support surface 236, the second support surface, and second sensor 112 can be located on third finger 154. In another alternative embodiment, left arm 228 and right arm 232 can be removed from third gripper 204. In another alternative embodiment, the second recess can be removed from third gripper 204 or may be used to perform a different function than gripping of an object. First support surface 236 is located the first distance D₁ (shown in FIG. 3) from base 106 in a direction perpendicular to the X-Y plane. The second support surface includes a leading edge 248 that abuts second surface 241. Leading edge 248 of the second support surface is located the second distance D₂ (shown in FIG. 3) from base 106 in a direction perpendicular to the X-Y plane.

With reference to FIGS. 5-7, second gripper 202 mounts to third portion 174 of second finger 152 and includes a first recess 250, a second recess 252, and a third recess 254. First recess 250 includes a first support surface 256 and a first surface 257. First support surface 256 is directed toward fourth finger 156 and is generally parallel to plane X-Y. First surface 257 abuts first support surface 256 forming a right angle opening toward fourth finger 156 and base 106 thereby allowing an object to be nested within the right angle formed by first recess 250. Second recess 252 includes a second support surface 258 and a second surface 259. Second support surface 258 is directed toward fourth finger 156 and is generally perpendicular to plane X-Y. Second surface 259 abuts second support surface 258 forming a right angle opening toward fourth finger 156 and away from base 106 thereby allowing an object to be nested within the right angle formed by second recess 252. Third recess 254 includes a third support surface 260 and a third surface 261. Third support surface 260 is directed toward fourth finger 156 and is generally perpendicular to plane X-Y. Third surface 261 abuts third support surface 260 forming a right angle opening toward fourth finger 156 and away from base 106 thereby allowing an object to be nested within the right angle formed by third recess 254.

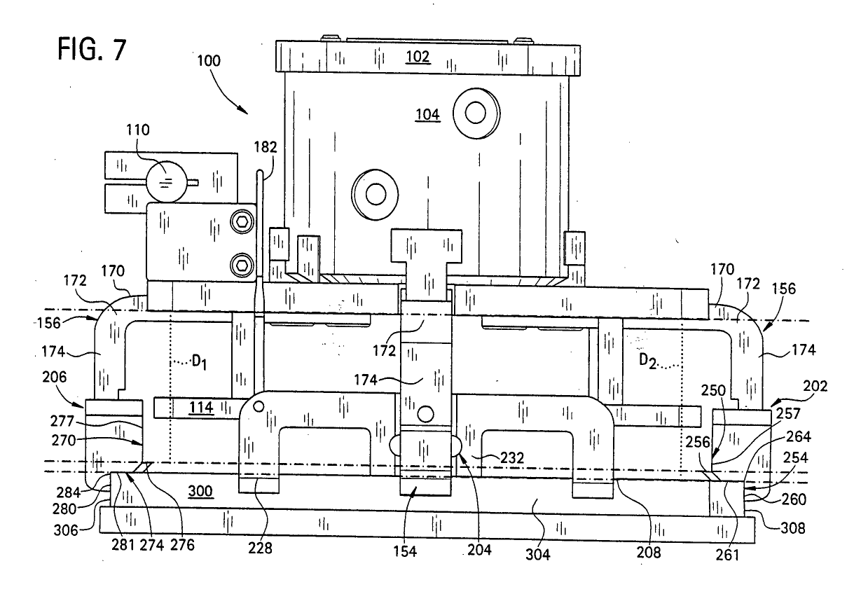

First support surface 256 is located the first distance D₁ from base 106 in a direction perpendicular to the X-Y plane. Second support surface 258 includes a leading edge 262 that abuts second surface 259. Leading edge 262 of second support surface 258 is located the second distance D₂ from base 106 in a direction perpendicular to the X-Y plane. Third support surface 260 includes a leading edge 264 that abuts third surface 261. Leading edge 264 of third support surface 260 is located the second distance D₂ (shown in FIG. 7) from base 106 in a direction perpendicular to the X-Y plane. Second support surface 258 and third support surface 260 are located on either side of first support surface 256. In an alternative embodiment, second support surface 258 and third support surface 260 may be combined to form a continuous surface.

With reference to FIGS. 2, 6, and 7, fourth gripper 206 mounts to third portion 174 of fourth finger 156 and includes a first recess 270, a second recess 272, and a third recess 274. First recess 270 includes a first support surface 276 and a first surface 277. First support surface 276 is directed toward second finger 152 and is generally parallel to plane X-Y. First surface 277 abuts first support surface 276 forming a right angle opening toward second finger 152 and base 106 thereby allowing an object to be nested within the right angle formed by first recess 270. Second recess 272 includes a second support surface 278 and a second surface 279. Second support surface 278 is directed toward second finger 152 and is generally perpendicular to plane X-Y. Second surface 279 abuts second support surface 278 forming a right angle opening toward second finger 152 and away from base 106 thereby allowing an object to be nested within the right angle formed by second recess 272. Third recess 274 includes a third support surface 280 and a third surface 281. Third support surface 280 is directed toward second finger 152 and is generally perpendicular to plane X-Y. Third surface 281 abuts third support surface 280 forming a right angle opening toward second finger 152 and away from base 106 thereby allowing an object to be nested within the right angle formed by third recess 274.

First support surface 276 is located the first distance D₁ from base 106 in a direction perpendicular to the X-Y plane. Second support surface 278 includes a leading edge 282 that abuts second surface 279. Leading edge 282 of second support surface 278 is located the second distance D₂ from base 106 in a direction perpendicular to the X-Y plane. Third support surface 280 includes a leading edge 284 that abuts third surface 281. Leading edge 284 of third support surface 280 is located the second distance D₂ from base 106 in a direction perpendicular to the X-Y plane. Second support surface 278 and third support surface 280 are located on either side of first support surface 276. In an alternative embodiment, second support surface 278 and third support surface 280 may be combined to form a continuous surface.

A fewer or a greater number of fingers may be used. A minimum of two generally opposed fingers is needed to provide gripping of the object with at least two support surfaces. A fewer or a greater number of support surfaces may be located on the plurality of fingers 108. For example, a single support surface may be located on a finger or a gripper that extends from the finger. Structures other than a recess also may be used to provide a plurality of support surfaces to support different object types. For example, grooves, slots, notches, gaps, etc. having different cross sections may be used without limitation. Thus, a circular cross section may be used in an alternative embodiment to form one or more support surface.

With reference to FIGS. 3 and 7, a first side view and a second side view of gripping apparatus 100 holding a plate 300 is shown in accordance with an exemplary embodiment. A first side 302 of plate 300 is held against second recess 218 of first gripper 200. First side 302 is also held against third support surface 224 and fourth support surface 226 of first gripper 200. A third side 304 of plate 300 is held against second recess of third gripper 204. Third side 304 is also held against third support surface 244 and fourth support surface 246 of third gripper 204. A fourth side 306 of plate 300 is held against second support surface 278 and third support surface 280 of fourth gripper 206. A second side 308 of plate 300 is held against second support surface 258 and third support surface 260 of second gripper 202. The sides 302, 304, 306 of plate 300 are held against support surfaces 220, 224, 246, 244, 246, 258, 260, 278, 280, by friction and by the closing force of the plurality of fingers 108.

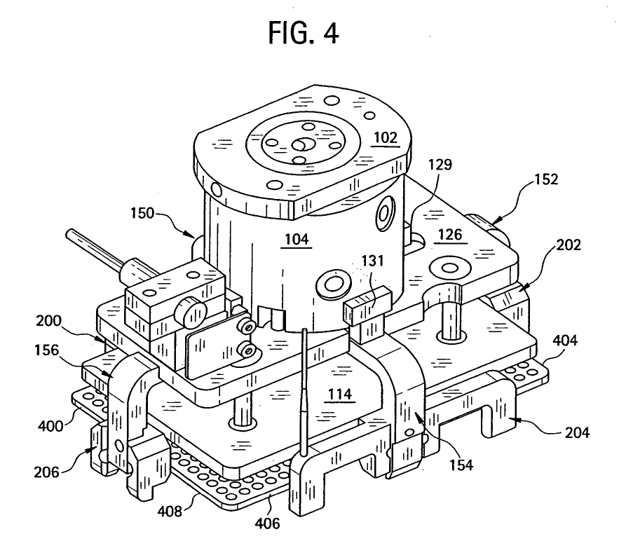

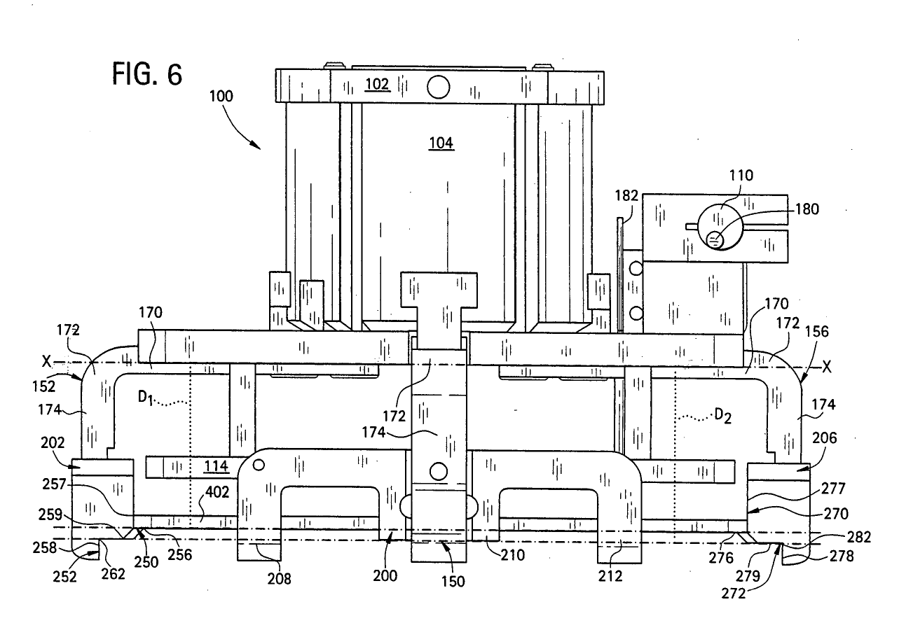

With reference to FIGS. 4-6, a top perspective view, a first side view, and a second side view of gripping apparatus 100 holding a pipette tip plate 400 are shown in accordance with an exemplary embodiment. A first side 402 (shown in FIG. 6) of plate 400 is supported by first support surface 216 of first recess 214 of first gripper 200. A second side 404 of plate 400 is supported by first support surface 256 of first recess 250 of second gripper 202. A third side 406 of plate 400 is supported by first support surface 236 of first recess 234 of third gripper 204. A fourth side 408 of plate 400 is supported by first support surface 276 of first recess 270 of fourth gripper 206.

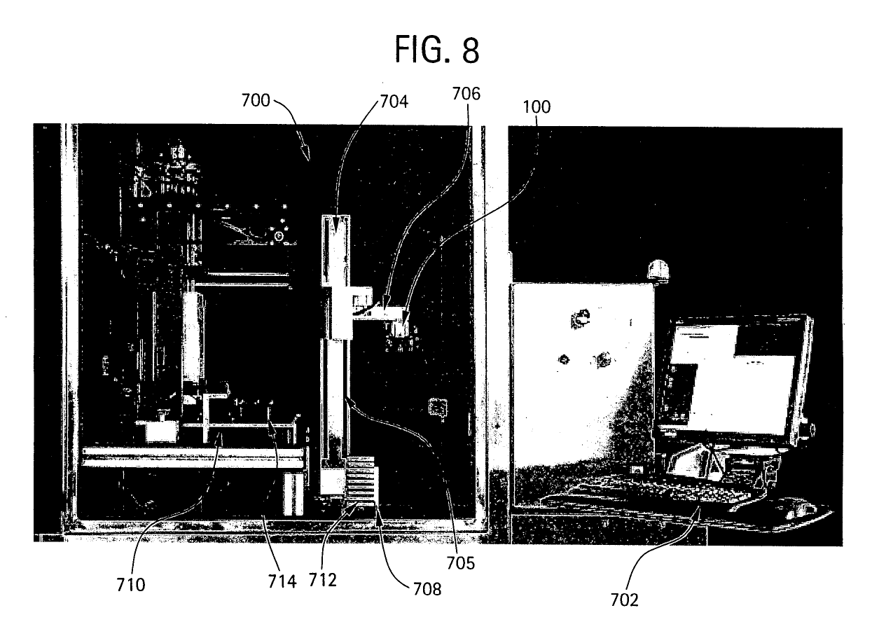

With reference to FIG. 8, an automated laboratory system 700 is shown in accordance with an exemplary embodiment. Automated laboratory system 700 may include a controller 702, a support arm 704, a robotic arm 706, gripping apparatus 100, a pipette tip rack 708, and an instrument 710. In an exemplary embodiment, controller 702 includes a computer of any form factor executing one or more program implemented in software, hardware, and/or firmware to control movement of robotic arm 706 and gripping apparatus 100. Controller 702 may further control components of instrument 710. As a result, controller 702 may interface with robotic arm 706, gripping apparatus 100, and/or instrument 710 as known to those skilled in the art both now and in the future. In alternative embodiments, there may be a plurality of controllers.

Robotic arm 706 mounts to support arm 704, which is located adjacent instrument 710. In an exemplary embodiment, support arm 704 provides a track 705 that supports movement along the support arm 704 though other arrangements are possible as known to those skilled in the art both now and in the future. For example, support arm 704 may support movement in a vertical direction. In alternative embodiments, there may be a plurality of support arms. In an exemplary embodiment, robotic arm 706 is a multi-link structure providing movement about a plurality of axes defined at a point on support arm 704. Robotic arm 706 can be any suitable robotic arm including, but not limited to, a KiNEDx-series (Peak Robotics Inc., Colorado Springs, Colo.) robotic arm, a Trx (AB Controls, Inc., Irvine Calif.) robotic arm, etc.

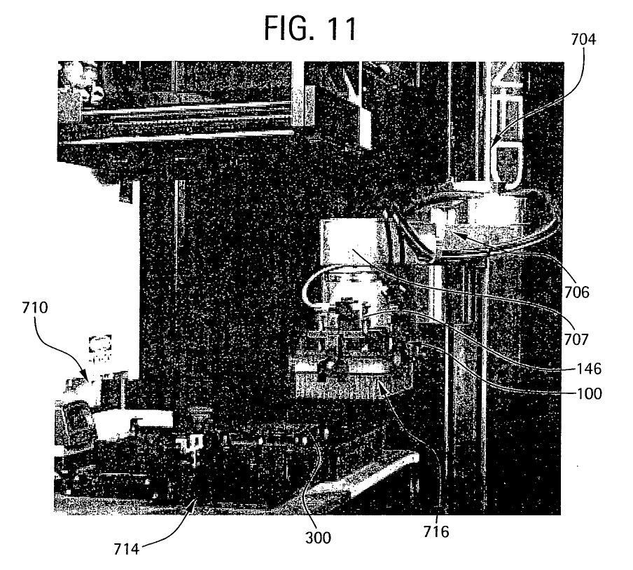

Gripping apparatus 100 mounts to a free end 707 (shown in FIG. 10) of robotic arm 706 opposite support arm 704. The orientation at which gripping apparatus 100 mounts to free end 707 of robotic arm 706 is exemplified as vertical in FIG. 11; however, mounting can be in any suitable orientation that enables the desired translational motion to gripping apparatus 100. Pipette tip rack 708 holds a plurality of pipette tip flats 712 in a stacked arrangement. Instrument 710 may be any of a variety of laboratory instruments as known to those skilled in the art both now and in the future without limitation. For example, instrument 710 may be a pipetting workstation, a compound plate replication platform, an assay workstation, a plate reader, a detector, etc. Instrument 710 may include a workbed 714.

With reference to FIGS. 8-10, in an exemplary process, controller 702 sends a movement command to robotic arm 706 to move gripping apparatus 100 in the direction of pipette tip rack 708 to pick-up a pipette tip flat 716. Robotic arm 706 moves toward pipette tip rack 708 until it is positioned above pipette tip flat 716. Robotic arm 706 moves down toward pipette tip flat 716. First sensor 110 searches for pipette tip flat 716, for example, using capacitance or light waves. Searching for pipette tip flat 716 reduces failure associated with different pipette tip lengths and pipette tip plate 400 thicknesses due to manufacturing inconsistencies or different types of pipette tips. At a distance above pipette tip flat 716, first sensor 110 detects a second pipette tip plate 802 and determines the distance to second pipette tip plate 802. Second pipette tip plate 802 fits above the pipette tips held in the pipette tip flat 716.

First sensor 110 detects contact between second pipette tip plate 802 and contact plate 114 and determines a withdrawal distance D₃ (shown with reference to fourth stem 136) of first stem 130. Spring 148 of first stem 130 compresses against plate 124 as contact plate 114 moves upward until the appropriate withdrawal distance is reached for first stem 130. The appropriate withdrawal distance, for example, may be based on the type of pipette tips held in pipette tip flat 716, and thus, the distance between pipette tip plate 400 and second pipette tip plate 802. First sensor 110 sends a signal to controller 702 and/or the actuator to close at least one of the plurality of fingers 108. In the exemplary embodiment of FIG. 1, first portion 170 of each of the plurality of fingers 108 is moved by the actuator toward the opposed finger to center and to hold pipette tip flat 716. At this point, pipette tip plate 400 is supported by first support surfaces 216, 236, 256, 276. Spring force from spring 148 of each stem 130, 132, 134, 136 and contact plate 114 hold the pipette tips upright for insertion at a desired position on workbed 714 thereby reducing failures. First sensor 110 sends a signal to controller 702 and/or the actuator indicating that pipette tip plate 400 is held by gripping apparatus 100. First sensor 110 may also be used to perform the sensing functions for other types of objects including a microtiter plate 300. Second sensor 112 can be used to perform similar operations to those discussed relative to first sensor 110 for various types of objects including a pipette tip plate 400 and a microtiter plate 300. One or more sensors may be included to provide the sensing functions.

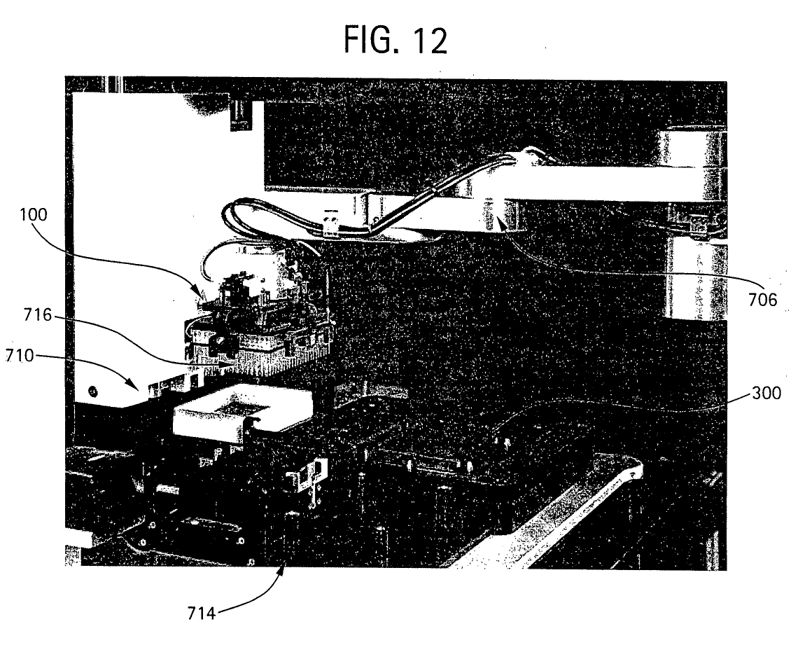

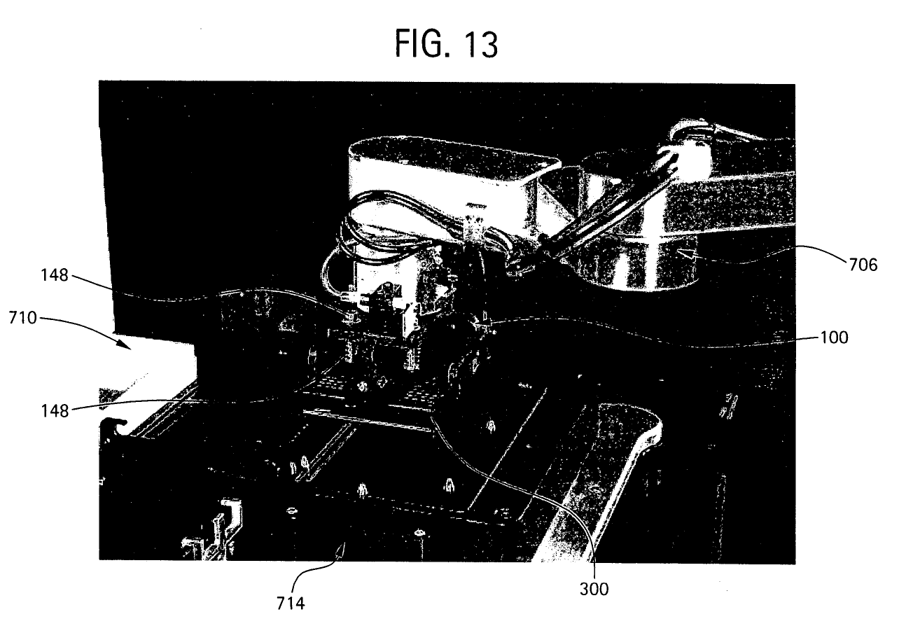

With reference to FIG. 10, controller 702 sends a movement command to robotic arm 706 to move pipette tip plate 400 to the desired position on workbed 714. With reference to FIGS. 11 and 12, robotic arm 706 moves pipette tip plate 400 toward the desired position on workbed 714. Workbed 714 may include a plurality of plates 300. For example, workbed 714 may include a plurality of microtiter plates. With reference to FIG. 13, a top perspective view of robotic arm 706 moving gripping apparatus 100 holding plate 300 is shown. Because gripping apparatus 100 can hold multiple types of objects, the size and cost of the automated laboratory system 700 can be reduced, the software used to control robotic arm 706 and gripping apparatus 100 is simplified, and the throughput, capacity, and unattended processing time of automated laboratory system 700 can be increased.

The foregoing description of exemplary embodiments of the invention have been presented for purposes of illustration and of description. It is not intended to be exhaustive or to limit the invention to the precise form disclosed, and modifications and variations are possible in light of the above teachings or may be acquired from practice of the invention. For example, non-rectangular objects also can be held by the gripping apparatus. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. An apparatus for gripping a plurality of object types, the apparatus comprising:
a sensor to detect an object that comprises one of a first type of object and a second type of object;
a base, wherein the base includes a generally planar surface, and further wherein a first direction is perpendicular to a plane defined by the generally planar surface of the base;
a first finger extending relative to the base, the first finger including a first support surface and a second support surface, the first support surface located a first distance relative to the base as measured in the first direction, the second support surface located a second distance as measured relative to the base in the first direction, wherein the first distance is selected based on the first type of object, wherein the second distance is selected based on the second type of object, and further wherein the second distance is different from the first distance;
a second finger extending relative to the base, the second finger including a third support surface and a fourth support surface, the third support surface located the first distance relative to the base as measured in the first direction, the fourth support surface located the second distance relative to the base as measured in the first direction, and further wherein the first finger opposes the second finger; and
an actuator operably coupled to the sensor to effect movement of at least one of the fingers to hold a detected object.

2. The apparatus of claim 1, further comprising:
a third finger extending relative to the base, the third finger including a fifth support surface, the fifth support surface located the first distance relative to the base as measured in the first direction;
a fourth finger extending relative to the base, the fourth finger including a sixth support surface, the sixth support surface located the first distance relative to the base as measured in the first direction, and further wherein the third finger opposes the fourth finger.

3. The apparatus of claim 2,
wherein the third finger further includes a seventh support surface, the seventh support surface located the second distance relative to the base as measured in the first direction; and
wherein the fourth finger further includes an eighth support surface, the eighth support surface located the second distance relative to the base as measured in the first direction.

4. The apparatus of claim 1, further comprising:
a third finger extending relative to the base, the third finger including a fifth support surface, the fifth support surface located the first distance relative to the base as measured in the first direction;
a fourth finger extending relative to the base, the fourth finger including a sixth support surface, the sixth support surface located the second distance relative to the base as measured in the first direction, and further wherein the third finger opposes the fourth finger.

5. The apparatus of claim 1, wherein the first type of object is selected from the group consisting of a container, a vessel, a single well plate, a multiwell plate, a flat, a rack, a lid, and a tool.

6. The apparatus of claim 5, wherein the second type of object is a pipette tip flat.

7. The apparatus of claim 1, further comprising a second sensor, wherein the second sensor detects the second type of object.

8. The apparatus of claim 1, wherein the first sensor further determines a distance to the object.

9. The apparatus of claim 1, wherein the first sensor mounts to one of the fingers.

10. The apparatus of claim 9, wherein the first sensor is a through-beam sensor.

11. The apparatus of claim 1, wherein the first sensor mounts to the base.

12. The apparatus of claim 11, further comprising:
a contact plate connected to the base by a stem, wherein the contact plate fits between the first finger and the second finger;
wherein the first sensor further detects contact between the object and the contact plate.

13. The apparatus of claim 12, wherein the contact plate moves toward the base along the stem when the object contacts the contact plate.

14. The apparatus of claim 13, further comprising a spring connected between the contact plate and the base, the spring compressing when the contact plate moves toward the base.

15. The apparatus of claim 14, wherein the spring encircles the stem.

16. The apparatus of claim 12, further comprising a plurality of stems.

17. The apparatus of claim 1, further comprising an actuator jaw operably coupled to move under control of the actuator wherein the first finger mounts to the actuator jaw.

18. The apparatus of claim 1, further comprising an actuator jaw operably coupled to move under control of the actuator wherein the first finger is integrally formed with the actuator jaw.

19. An apparatus for gripping a plurality of object types, the apparatus comprising: a sensor to detect an object that comprises one of a first type of object and a second type of object;
a base, wherein the base includes a generally planar surface, and further wherein a first direction is perpendicular to a plane defined by the generally planar surface of the base;
a first finger extending relative to the base, the first finger including a first support surface, the first support surface located a first distance relative to the base as measured in the first direction, wherein the first distance is selected based on the first type of object;
a second finger extending relative to the base, the second finger including a second support surface, the second support surface located a second distance relative to the base as measured in the first direction, wherein the second distance is selected based on the second type of object, and further wherein the second distance is different from the first distance;
a third finger extending relative to the base, the first finger including a third support surface, the third support surface located the first distance relative to the base as measured in the first direction, wherein the third finger opposes the first finger;
a fourth finger extending relative to the base, the fourth finger including a fourth support surface, the fourth support surface, located the second distance relative to the base as measured in the first direction, wherein the fourth finger opposes the second finger; and
an actuator operably coupled to the sensor to effect movement of at least one of the fingers to hold a detected object.

20. An apparatus for transporting a plurality of object types, the apparatus comprising:
a robotic arm;
a gripping apparatus mounted on the robotic arm, the gripping apparatus comprising
a sensor receiving a detection command to detect an object that comprises one of a first type of object and a second type of object;
a base, wherein the base includes a generally planar surface, and further wherein a first direction is perpendicular to a plane defined by the generally planar surface of the base;
a first finger extending relative to the base, the first finger including a first support surface and a second support surface, the first support surface located a first distance relative to the base as measured in the first direction, the second support surface located a second distance as measured relative to the base in the first direction, wherein the first distance is selected based on the first type of object, wherein the second distance is selected based on the second type of object, and further wherein the second distance is different from the first distance;
a second finger extending relative to the base, the second finger including a third support surface and a fourth support surface, the third support surface located the first distance relative to the base as measured in the first direction, the fourth support surface located the second distance relative to the base as measured in the first direction, and further wherein the first finger opposes the second finger; and
an actuator operably coupled to the sensor to effect movement of at least one of the fingers to hold a detected object; and
a controller operably coupled to the gripping apparatus and to the robotic arm, the controller sending the detection command to the gripping apparatus and sending a movement command to the robotic arm to move the gripping apparatus.

21. The apparatus of claim 20, wherein the sensor further searches for the object as the robotic arm moves the gripping apparatus.

22. A method for gripping a plurality of object types, the method comprising:
detecting an object with a sensor in response to a received command; and
gripping the detected object with a support surface of a gripping apparatus, the gripping apparatus comprising
a base, wherein the base includes a generally planar surface, and further wherein a first direction is perpendicular to a plane defined by the generally planar surface of the base;
a first finger extending relative to the base, the first finger including a first support surface and a second support surface, the first support surface located a first distance relative to the base as measured in the first direction, the second support surface located a second distance relative to the base as measured in the first direction, wherein the first distance is selected based on a first type of object, wherein the second distance is selected based on a second type of object, and further wherein the second distance is different from the first distance;
a second finger extending relative to the base, the second finger including a third support surface and a fourth support surface, the third support surface located the first distance relative to the base as measured in the first direction, the fourth support surface located the second distance relative to the base as measured in the first direction, and further wherein the first finger opposes the second finger; and
an actuator operably coupled to the sensor to effect movement of at least one of the fingers to hold the detected object, wherein the detected object is one of the first type of object and the second type of object.

23. The method of claim 22, wherein the gripping apparatus further comprises:
a third finger extending relative to the base, the third finger including a fifth support surface, the fifth support surface located the first distance relative to the base as measured in the first direction;
a fourth finger extending relative to the base, the fourth finger including a sixth support surface, the sixth support surface located the first distance relative to the base as measured in the first direction, and further wherein the third finger opposes the fourth finger.

24. The method of claim 23, wherein the third finger further includes a seventh support surface, the seventh support surface located the second distance relative to the base as measured in the first direction; and wherein the fourth finger further includes an eighth support surface, the eighth support surface located the second distance relative to the base as measured in the first direction.

25. The method of claim 22, further comprising determining a distance to the object.

26. The method of claim 22, further comprising detecting contact between the object and a contact plate of the gripping apparatus, the contact plate connected to the base by a stem and fitting between the first finger and the second finger.

27. The method of claim 26, further comprising allowing the contact plate to move toward the base along the stem when the object contacts the contact plate.

28. The method of claim 27, further comprising compressing a spring connected between the contact plate and the base when the object contacts the contact plate.

29. The method of claim 22, further comprising sending a movement command to a robotic arm, the gripping apparatus mounted to the robotic arm.

30. The method of claim 29, further comprising moving the gripping apparatus toward the object using the robotic arm.

31. The method of claim 30, further comprising searching for the object as the gripping apparatus moves toward the object.
